(19) United States
(12) Patent Application Publication
(10) Pub. No.: US 2008/0218727 A1
(43) Pub. Date: Sep. 11, 2008

(54) METHOD AND APPARATUS FOR OPTICAL IMAGE RECONSTRUCTION USING CONTOUR DETERMINATION

(75) Inventors: Salim Djeziri, Montreal (CA); Niculae Mincu, Pointe-Claire (CA); Frederic Leblond, Montreal (CA); Olga Guilman, Montreal (CA); Xavier Intes, Troy, NY (US); Mario Khayat, Montreal (CA)

Correspondence Address: BERESKIN AND PARR, 40 KING STREET WEST, BOX 401, TORONTO, ON, M5H 3Y2, CA

(73) Assignee: ART, Advanced Research Technologies Inc., Saint-Laurent (CA)

(21) Appl. No.: 11/962,911

(22) Filed: Dec. 21, 2007

Related U.S. Application Data
(60) Provisional application No. 60/871,767, filed on Dec. 22, 2006.

(51) Int. Cl. G01C 11/12

(52) U.S. Cl. 356/2

(57) ABSTRACT

The present invention relates to a method and a system for optical imaging of an object in transmission configuration. The method and system obtain contour coordinates of the object using source/detector configurations references and acquire optical data from a region of interest (ROI) of the object. Then, the method and system apply a weighting factor to said optical data as a function of the contour coordinates, and reconstruct an image of the ROI using the weighted optical data and photon diffusion equation.

### FIELD OF THE INVENTION

The invention relates to optical imaging of biological tissue.

### BACKGROUND OF THE INVENTION

Optical imaging of turbid media such as the human breast has been the subject of extensive research activity and has seen an increase in interest since the early 1990s. This type of imaging is based on the fact that the propagation of light in a turbid medium depends on the absorption and scattering properties of the medium. The absorption property of the medium is quantified by its absorption coefficient defined as the probability of a photon being absorbed per infinitesimal pathlength. Scattering results from variations in the index of refraction of the different structures present in the medium. In a highly diffusive medium, scattering is quantified by the reduced scattering coefficient defined as a measure of the probability of a photon to be scattered per infinitesimal pathlength. Characteristics such as intensity, coherence and polarization of the incident light change as it is absorbed and scattered by the medium resulting in diffuse transmittance of the light.

The strong interest in optical imaging of scattering media stems from the need for biomedical diagnostic techniques that are safe and non-invasive. The optical properties of biological tissues are at the heart of optically based biomedical diagnostic techniques. As for the general case of a turbid medium, the manner in which light propagates through tissue depends on its absorption and scattering properties. Thus, if abnormal tissue can be said to differ from normal in its absorption or scattering of light for some physiological or morphological reason, it then becomes possible to optically differentiate between normal and abnormal conditions. A specific application is optical mammography where tumors could be differentiated from normal breast tissue on the basis of optical properties.

There are many types of biomedical optical imaging but for breast imaging the following techniques are mainly used: tomography and transillumination. Tomography is typically based on a multi-point geometry involving a large number of illumination-detection points and allows the reconstruction of 3D images. Reference to an article by S. B. Colak, D. G Papaioannou, G. W. Hooft, M. B. Van der Mark, H. Schomberg, J. C. J. Paasschens, J. B. M. Melissen, and N. A. A. J. Van Asten, titled “Tomographic image reconstruction from optical projections in light-diffusing media,” published in Appl. Opt., 36, 180-213 (1997) can be made for a discussion on tomography. Obtaining 3D information is an important advantage of tomography, however, measurements and reconstructions are potentially time-consuming.

Transillumination (or 2D projection imaging) refers to a scanning procedure in which each image pixel is determined from the detection of the light that enters the medium through a certain entrance area, that propagates through it and that exits over a certain detection area usually facing the entrance area. The light entering the medium is generated by a light source, typically a laser source. For obtaining a good spatial resolution, the detection of the emerging light is typically done over a detection area, which is small compared to the area of interest from which the light emerges at the output surface.

In optical tomography, mathematical formulas and projection techniques have been devised to perform a reconstruction function somewhat similar to x-ray tomography. However, because light photon propagation is not straight-line, techniques to produce cross-section or 3D images are mathematically complex, involving models as diffusion equation or radiative transfer equation, and require establishing the boundary of the scanned object. Boundary determination is important because it serves as the basis for solving the equations and for using them for defining a priori spatial constraints that help reconstruction techniques to produce more accurate values for the optical parameters and increased spatial resolution for interior structure details.

Further, differential equations such as the diffusion equation and the like involve a bothersome problem that even with any numerical computation approach such as the analytical or finite element method, boundary conditions (the shape of the medium, reflection characteristics at interfaces, etc.) must be preliminarily set and then a solution can be determined. Namely, in the case of the measured object like living tissue, the boundary conditions normally vary depending upon a place to be measured, the wavelength of light used in measurement, and so on, and for improvement in accuracy on the basis of correction for influence of these factors, it is necessary to repeat complicated calculations at every change of the boundary conditions, which results in a problem of extremely long calculation time.

However, scattering media for which the boundary conditions can be set accurately to some extent are limited to very simple shapes such as an infinite space, a semi-infinite space, a circular cylinder having infinite length, a slab spreading infinitely and having a finite thickness, and a sphere. As a result, use of approximate boundary conditions is indispensable in measurements of living tissues having complicated shapes, which is a cause to produce large measuring errors. This problem is also discussed, for example, in the recent literature; Albert Cerussi et al., “The Frequency Domain Multi-Distance Method in the Presence of Curved Boundaries,” in Biomedical Optical Spectroscopy and Diagnostics, 1996, Technical Digest (Optical Society of America, Washington D.C., 1996) pp. 24-26. Summarizing the above problem, any measuring methods that can be systematically applied to scattering media of different shapes have not been developed yet and it is impossible for the conventional technologies to accurately measure the concentration of a specific absorptive constituent inside the scattering media of different shapes systematically.

There is therefore a need for improving image reconstruction in optical imaging of biological tissue.

### SUMMARY OF THE INVENTION

In a broad aspect of the invention, there is provided a method for improving image reconstruction in optical imaging by taking in consideration a contour of an object to be optically imaged in the reconstruction algorithm. The method advantageously eliminates edge effects and provides for a faster and more accurate image reconstruction.

Thus in one embodiment, there is provided a method for optical imaging of an object in transmission configuration, the method comprising obtaining the contour coordinates of the object, acquiring optical data from a region of interest (ROI) of the object, applying weighting factors to the optical data as a function of the contour coordinates, and reconstructing a 3D image of the ROI using the weighted optical data and a photon diffusion equation.

In another embodiment, there is provided a method for optical imaging of an object in transmission configuration, the method comprising obtaining contour coordinates of the object, determining a region of interest (ROI) within the contour coordinates, and acquiring optical data from the ROI of the object wherein the acquiring of optical data comprises adjusting a light source intensity as a function of the contour coordinates to maximize signal to noise ratio within the ROI.

### BRIEF DESCRIPTION OF THE DRAWINGS

Further features and advantages of the present invention will become apparent from the following detailed description, taken in combination with the appended drawings, in which:

FIG. 1A is a perspective view of a schematic representation of an object (breast) comprised between parallel plates for optical imaging in transmission configuration;

FIG. 1B is a cross-sectional top view of the embodiment shown in FIG. 1A,

FIG. 2 is a perspective view of a source-detector configuration in which some of the photon paths do not intersect the object,

FIG. 3A is an example of a displayed contour profile,

FIG. 3B is an example of a displayed contour profile with the corresponding image of an object (breast),

FIG. 4A is a contour profile with an optical image showing a region of interest (ROI) of an object (breast),

FIG. 4B is the contour profile as shown in FIG. 4A with a different ROI of the object,

FIG. 5A is a schematic representation of source detector configurations,

FIG. 5B illustrates a geometry using a finite element mesh on a typical slab dimension of 96×96×60 mm having a total of 1024 source positions (32 along y direction by 32 along x-direction) shown at the bottom of the slab and 5120 detector locations indicated at the top of the slab (at z=60 mm),

FIG. 5C shows the separation of the scan points into lines along x-axis, with each line containing all the scan points along the y axis,

FIG. 6 is a schematic diagram of the system of the invention, and

FIG. 7 is a flow diagram of a method in accordance with an aspect of the present invention.

### DETAILED DESCRIPTION OF THE INVENTION

There is provided a method for acquiring optical images of an object such as a biological tissue. In a broad embodiment, the method advantageously provides for better image reconstruction by providing information on the object's contour thereby enabling better image reconstruction.

Light photons undergo absorption and scattering processes when passed through tissue and the diffusion equation approximates the bulk light propagation under the assumption that the diffuse fluence behaves as though the scattering is uniformly isotropic with a reduced scattering coefficient, μ′_{S}, when measured over long distances. This condition exists under the assumption that scatter dominates over absorption which is true in the case of several tissue types, including the human breast, in the wavelength region of 650-1350 nm. This differential equation is written as:

$$- ∇ \cdot κ ( r ) ∇ Φ ( r , ω ) + ( {μ}_{a} ( r ) + \frac{i ω}{c} ) Φ ( r , ω ) = {q}_{0} ( r , ω ) \qquad ( 1 )$$

where Φ(r, ω) is the isotropic fluence at modulation frequency w ω and position r, κ(r) is the diffusion coefficient, μₐ(r) is the absorption coefficient, c is the speed of light in the medium and q₀(r, ω) is an isotropic source. The time domain equation is expressed as:

$$∇ \cdot ( κ ∇ φ ( r , t ) ) - {μ}_{a} φ ( r , t ) = \frac{1}{c} \frac{\partial φ ( r , t )}{\partial t} - S ( r , t ) \qquad ( 2 )$$

where S(r,t) is the source. The diffusion coefficient can be written as

$$κ ( r ) = \frac{1}{3 [ {μ}_{a} ( r ) + {μ}_{s}^{′} ( r ) ]} , \qquad ( 3 )$$

where μ′_{S} is the reduced scattering coefficient. The time domain equation equivalent to equation 1 is well known in the art. Equation 1 can be solved using standard numerical techniques, such as the finite element model (FEM). The forward solver obtains the fluence for a given distribution of optical properties by applying suitable boundary conditions, for example type III (Robin-type) conditions.

One cost-efficient and robust approach to perform Diffuse Optical Tomography (DOT) is to solve the heterogeneous equation within the Rytov perturbative approach (O'Leary. PhD University of Pennsylvania 1996). In the case of time resolved measurements, there are potentially different types of data sets. One can select the 0^{th} moment (equivalent to continuous mode) and 1^{st} moment (mean time of photon arrival) of the TPSF (Arridge. Inverse problems (1999); 15:R41-R93). The DOT problem is thus expressed as:

$$[ \begin{matrix}{Φ}_{sc}^{( l )} ( {r}_{sd 1} ) \\ ⋮ \\ {Φ}_{sc}^{( l )} ( {r}_{sdm} ) \\ {Φ}_{sc}^{( MT )} ( {r}_{sd 1} ) \\ ⋮ \\ {Φ}_{sc}^{( MT )} ( {r}_{sdm} )\end{matrix} ] = [ \begin{matrix}{W}_{11}^{( l )} & ⋯ & {W}_{1 n}^{( l )} \\ ⋮ & ⋰ & ⋮ \\ {W}_{m 1}^{( l )} & ⋯ & {W}_{mn}^{( l )} \\ {W}_{11}^{( MT )} & ⋯ & {W}_{1 n}^{( MT )} \\ ⋮ & ⋰ & ⋮ \\ {W}_{m 1}^{( MT )} & ⋯ & {W}_{mn}^{( MT )}\end{matrix} ] [ \begin{matrix}δ {μ}_{a} ( {r}_{1} ) \\ ⋮ \\ {δμ}_{a} ( {r}_{n} )\end{matrix} ] \qquad ( 4 )$$

where

$${Φ}_{sc}^{( I )} ( {r}_{sdi} ) = ln ( \frac{U ( {r}_{sdi} )}{{U}_{0} ( {r}_{sdi} )} )$$

is the 0^{th} moment Rytov perturbation, Φ_{sc}^{(MT)}_{sdi}= t̅(r_{sdi})− t̅₀(r_{sdi}) the 1^{st} moment Rytov perturbation, with Wᵢⱼ^{(l)} and Wᵢⱼ^{(MT)} the corresponding weight of the sensitivity matrix. The expressions for the weight functions are:

$${W}_{ij}^{( l )} = \frac{1}{{( 4 π D )}^{2} {r}_{sivj} {r}_{vjdi}} \cdot exp [ - \sqrt{\frac{{μ}_{a}}{D}} \cdot ( {r}_{sivj} + {r}_{vjdi} ) ] \cdot \frac{1}{{U}_{0} ( {r}_{sdi} )} \\ {W}_{ij}^{( MT )} = \frac{( {r}_{sivj} + {r}_{vjdi} )}{c \cdot \sqrt{{μ}_{a} \cdot D} {( 4 π D )}^{2} {r}_{sivj} {r}_{vjdi}} \cdot exp [ - \sqrt{\frac{{μ}_{a}}{D}} \cdot ( {r}_{sivj} + {r}_{vjdi} ) ] \cdot \frac{1}{{U}_{0} ( {r}_{sdi} )} - ( \frac{{\overline{t}}_{0} ( {r}_{sdi} ) \cdot {W}_{ij}^{( l )}}{{U}_{0} ( {r}_{sdi} )} ) \qquad ( 5 )$$

with rₛᵢᵥⱼ and r_{vjdi} corresponding to the i^{th} source-j^{th} voxel and j^{th} voxel-i^{th} detector distances, respectively, and U₀(r_{sdi}) and t̅₀(r_{sdi}) correspond to the homogeneous 0^{th} moment and 1^{st} moment of the TPSF for the considered source detector-pair.

It will be appreciated that other approaches can be used to derive the scatter “map” of an object as would be known by those skilled in the art.

Models of light propagation within diffusing object comprising a fluorophore have also been developed and it will be appreciated that such models can also be used in the present invention.

Image reconstruction is an inverse problem, where optical images are obtained using surface measurements performed on the tissue surface. Typically, this involves the iterative minimization of an objective function based on the difference between the measured and the model data. The reconstruction can be based for example on minimization of the standard sum of squared differences between the measured and calculated optical radiance at specific detector locations. This least squares error norm, called the projection error, is given by:

$${χ}^{2} = {\sum }_{j = 1}^{M} {( {φ}_{j}^{m} - {φ}_{j}^{c} )}^{2} \qquad ( 3 )$$

where M is the total number of measurements at each wavelength, and φⱼ^{m} and φⱼ^{c} are the measured and calculated fluence at the boundary for the jth measurement point. The measured fluence can be obtained from eq 1 or 2. Minimization can be accomplished for example with a gradient-based Newton-Raphson method for iteratively updating the optical properties (starting with a homogeneous initial guess). Other minimization methods as would be known to those skilled in the art can also be used. The inversion can be stabilized using known methods.

As mentioned above, solutions to the diffusion equation are influenced by the geometry of the object being imaged. Irregular contours departing from the simple regular geometries will introduce distortion in the calculation of optical parameters of the object especially at the edges of the object.

Thus in one embodiment of the invention the optical data acquired from edge regions of the object, in which the geometry is not regular, are weighted or eliminated to reduce their negative impact on image reconstruction.

During data acquisition, based on the contour and the ROI defined by the user the system automatically establishes the “optimum ROI” (that is the overlap (or result of the intersection) between the region defined by the contour and the ROI defined by user; Data acquisition is confined in this optimum ROI. This helps maximizing the SNR—with a very significant improvement especially when the difference between the optical properties inside and outside the contour is more noticeable. The “optimum ROI” avoids wasting time by scanning points that are not relevant for the post-processing.

Prior to acquiring the optical data to reconstruct an image, the contour coordinates of the object are determined using the same reference (axes of coordinates) as for the source-detector configurations. The contour can be obtained by optically scanning the object, such as for example by raster scanning the object, to obtain a light intensity profile. Alternatively the contour can be determined by registering the position of the object relative to the source-detector configurations using a camera for example. The contour can be a two dimensional (2D) or three dimensional (3D) contour. It will also be appreciated that a 2D contour can be generated by tacking a “slice” of the 3D contour.

The object contour coordinates relative to the system configuration can be stored for future reference during image reconstruction. The conditions under which the contour is obtained can also be recorded and stored for future reference. Such conditions may include compression of the object, temperature and the like.

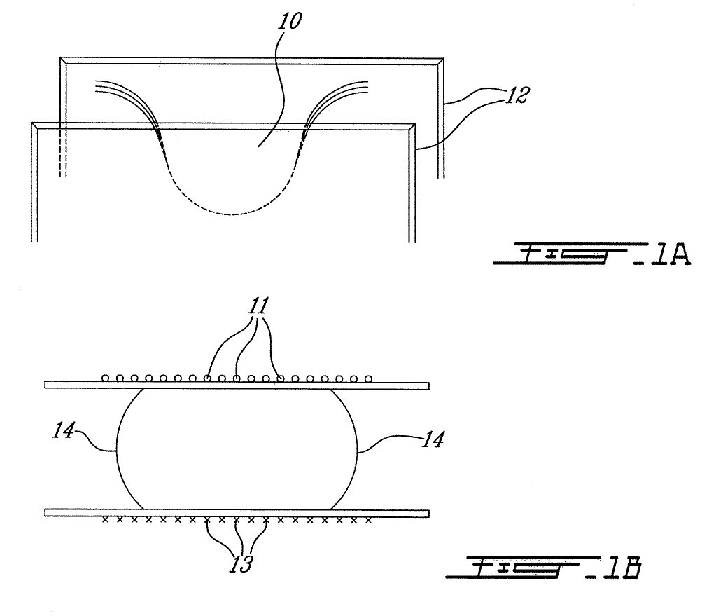

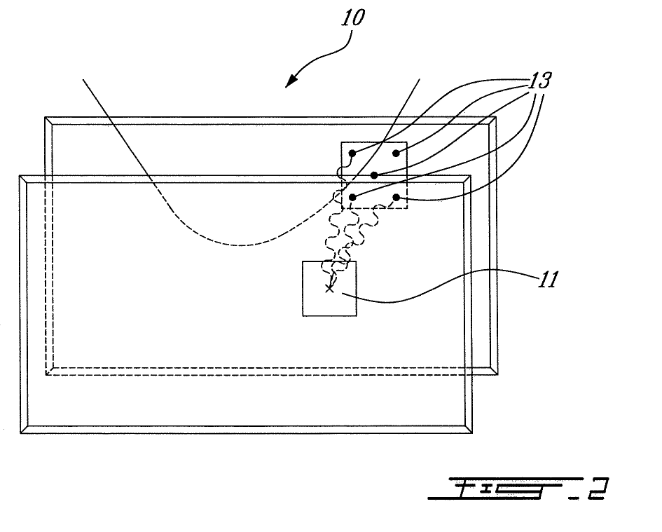

In one embodiment of the invention the optical data acquisition is performed in the transmission mode. Referring to FIG. 1, a schematic representation of an object 10 (a breast) in a transmission geometry is shown (side view FIG. 1A and cross-sectional top view FIG. 1B). In breast imaging, the breast is gently compressed between two plates 12. The plates are preferably substantially parallel to provide a rectangular geometry. The light source(s) 11 is coupled to one of the plate using for example optic fibers, and detectors 13 are positioned on the other plate thus allowing acquisition of the signal in a transmission mode. While the plates confer a generally rectangular shape to the object, it can be appreciated from the top view and the cross-sectional view that the edges 14 of the object are rounded. Therefore the object edges in these regions are not simple regular shapes.

A 3D contour can be obtained from an arrangement such as shown in FIG. 1 by obtaining a contour in a plane parallel to the plates or by assuming a certain shape of the object in the plane perpendicular to the plates.

The contour coordinates of the object can be used in the processing of the optical data for image reconstruction. In order to minimize the distortion of the image resulting from the reconstruction the optical data obtained from edge regions having irregular geometries can be selected or weighted. In the case where the detected optical signal results from photons that have not traveled in the object, this signal is excluded from the reconstruction by data filtering. An example of a source-detector configuration in which some of the photons do not travel within the object is shown in FIG. 2. As can be seen, the line of sight between the source 11 and some of the detectors 13 does not intersect the object.

In the case where the path of light from the source to the detector intersect the object but only partially, that is to say the light path between source and detector has a significant proportion that is outside of the object, a weighting factor is applied to the voxels outside of the sample region under investigation and is function of the optical properties of these voxels. For example the weight is zero if the contribution of that voxel is negligible (some non-diffusing and zero absorption medium). Otherwise the weight is set to a value that is known a priory because the surrounding medium has well known optical properties. This could be expanded to apply to situations with many boundary interfaces with the condition that the coordinates of the interfaces are known or can be determined and the volumes other than the one under investigation have known or independently measurable optical properties (scattering and absorption) (in instances where the geometry favors an independent evaluations for some of them the measurement could be performed in positions where the cross-talk between the regions is negligible) in order to be able to define the corresponding weighting factors. The weighting factor can also be a function of the proportion of object's volume comprised in the path of the photons. It can also be a function of the number of boundary interfaces crossed by the photons traveling from the source to the detector.

It will be appreciated that when multiple detectors are used for a single source, the signal detected at each detector may warrant a different weighing factor owing to its position relative to the source and the object.

It will be further appreciated that the weighting factor may depend on the wavelength used to obtain the optical data. For example, multiple wavelengths may be used to image an object and the weighting factor for a source-detector configuration may depend on the wavelength.

Once the contour of the object has been determined, a preliminary scan can be performed to obtain average optical characteristics of each of the regions separated by the measured contour, such μₐ and μₛ′ to be used in the reconstruction algorithm. Alternatively optical characteristics values can be obtained from previously recorded measurements for similar tissues or from the same subject.

In another aspect of the invention, the contour is used to determine a region of interest (ROI) that is comprised within the contour of the object. When scanning the object to obtain optical data for image reconstruction, the intensity of the source can be adjusted so that the signal to noise is maximized in the ROI that is comprised within the contour.

It will be appreciated that the ROI can also be determined by the user.

In an embodiment of the invention, for selection of the ROI, the previously measured contour is displayed inside the scanner field of view and the operator could use it to define the ROI.

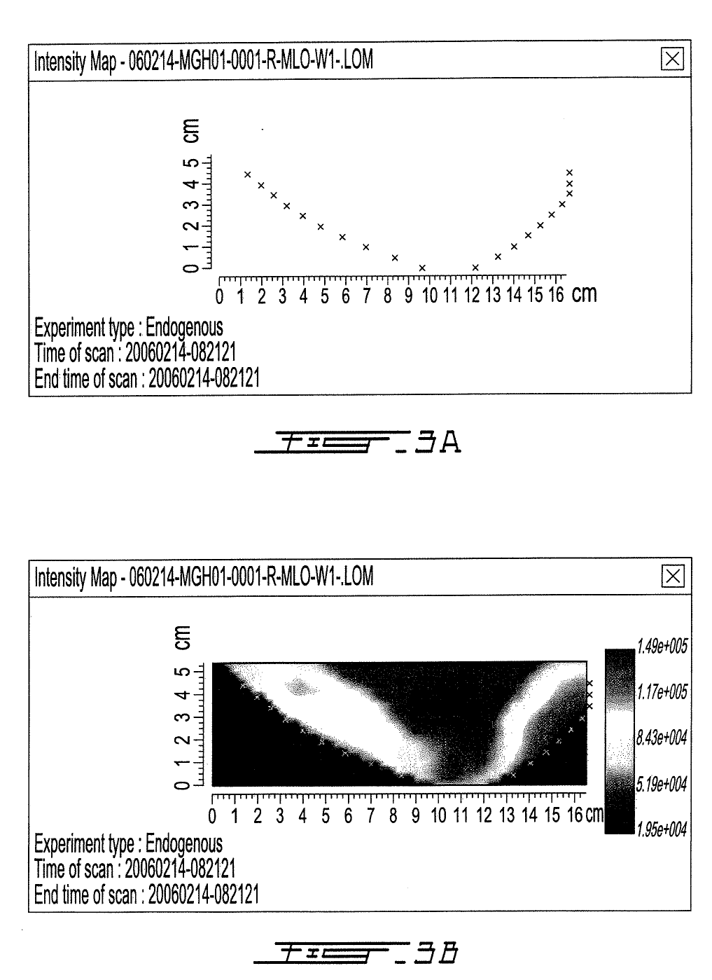

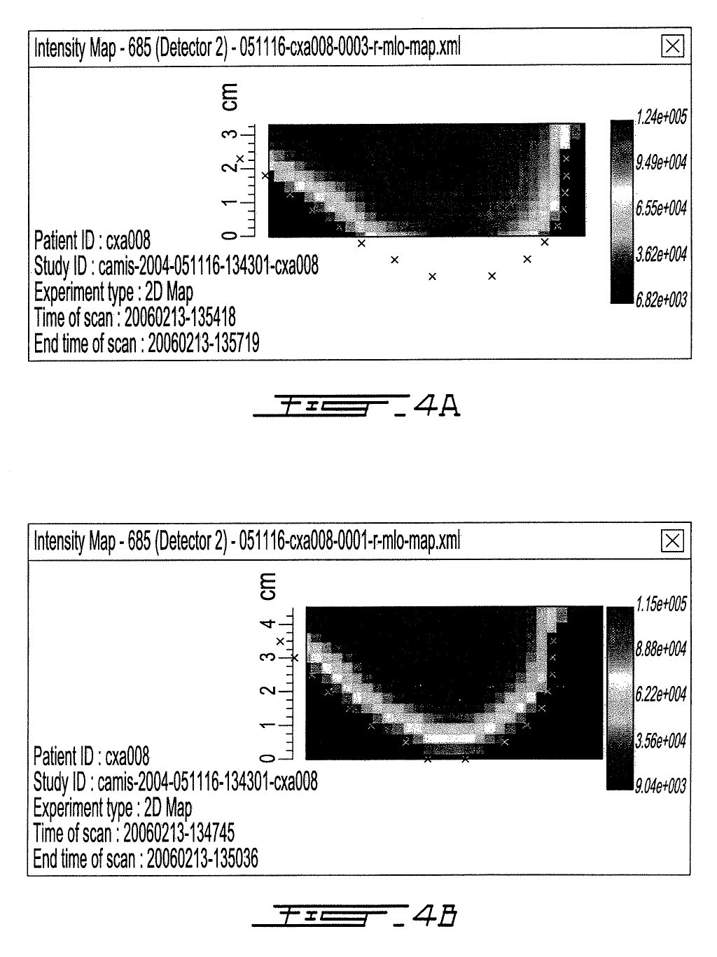

An example of a contour profile is shown in FIG. 3A, and FIG. 3B shows a contour profile together with the corresponding optical image of a breast.

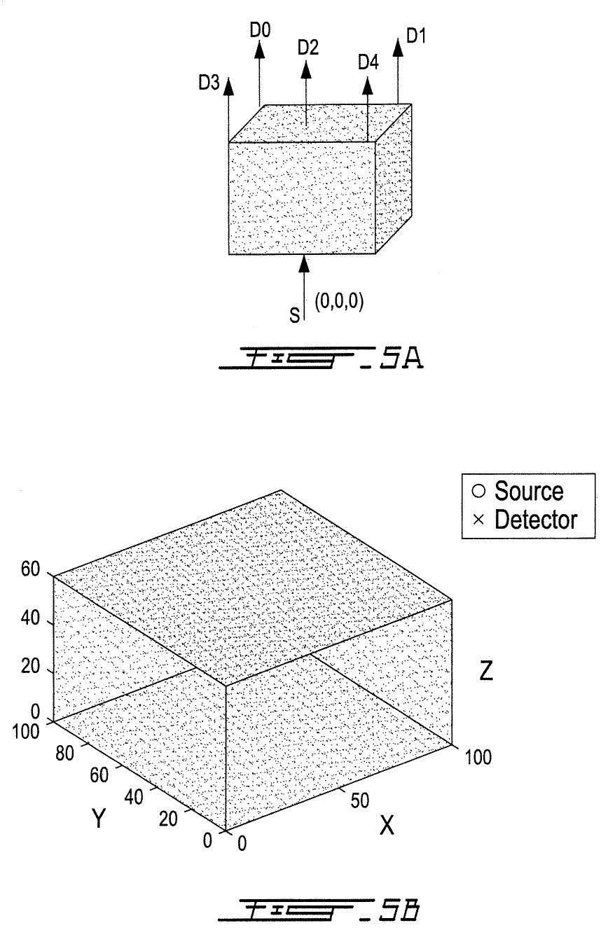

The contour also provides help for the co-localization of an ROI within optical images obtained from different scans. An example is provided in FIG. 4 in which optical images of two different ROI (FIGS. 4A and 4B) are shown in relation to the contour profile.

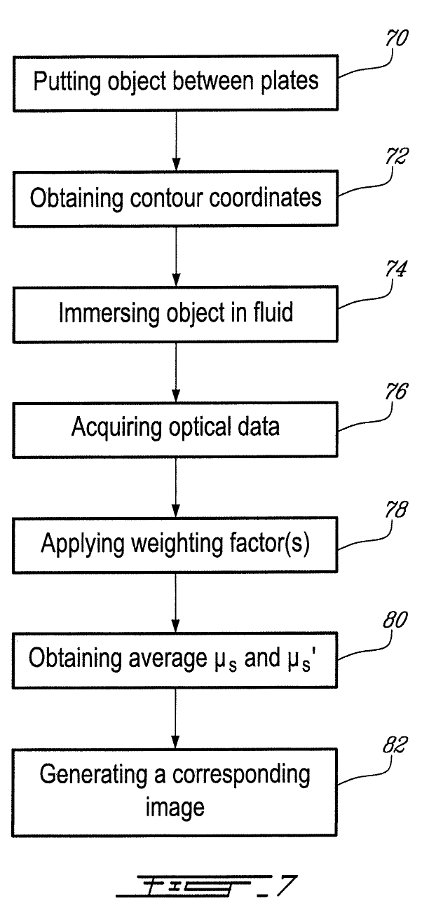

In an other aspect of the invention there is provided a system 60 (FIG. 6) for imaging an object in transmission configuration comprising a light source 61, for injecting light at one or more injection ports, one or more light detector 62 for detecting light transmitted through the object, an acquisition controller 63 for controlling source-detector positions and determining the acquisition parameter such as wavelength, light intensity, acquisition mode (CW, Time domain, Frequency Domain). The system further consists of a contour coordinates estimator 64 for acquiring and calculating contour coordinates of the object and an optical data estimator 65 for selecting optical data relevant to a ROI and to calculate and apply weighting factors to the optical data as a function of contour coordinates. The system may further include a co-located or separate optical image generator 66 for reconstructing an optical image based on said weighted optical data.

Reference is now made to FIG. 7, which depicts a flow diagram of a method of an aspect of the present invention. The method starts in step 70 with putting an object between parallel plates. The method then continues with a step 72 of obtaining contour coordinates for the object. The contour coordinates could be obtained by means of optical scanning, such as a raster scan. The method continues with a step 74 of immersing the object in optically matching fluid. Then, optical data is acquired in step 76. The optical data is acquired as previously described. After the optical data has been acquired, the method proceeds with a step 78 of applying weighting factors to the acquired optical data. As previously described the weighting factors take in consideration contour coordinates, and optical properties of the matching fluid. The method may also include a step 80 of obtaining an average μₛ and μ′ₛ. Then, the method proceeds with a step 82 of reconstructing an image of the object by excluding optical data for which photon paths are outside the contour coordinates, use weighted optical data, photon diffusion equation (s) and average of μₛ and μ′ₛ.

The matching liquid is added to increase the agreement between the data acquisition and the diffusion equation model. As in the present invention, the model is for slab geometry with a thickness d on Z-direction (along an axis of laser beam) and infinite extension on X-Y directions (or at least the distance between the point of the measurement and the edge of the slab should be large enough). Without the liquid all the data acquired at a distance smaller than 30-35 mm from the edge does not comply with the assumptions of the model and the results of the post-processing will be incorrect.

Knowing exactly the position of the interface tissue-liquid is helpful for the 3D reconstruction. When the optical properties of the fluid match the ones of the tissue is the ideal case and the correction for the liquid contribution is not significant. In reality, it is hard to match the diversity of the optical properties of the breast tissue.

The propagation of the light is so diffuse that a photon could travel long paths through large volumes of the media before being detected at the opposite side. In this case, the photon's path will be affected by both regions of the medium and the results will be a weighted (averaged) contribution of both media. By knowing the properties of the fluid and “forcing” these known values in the reconstruction algorithm for that region of the medium allows to recover the right properties of the tissue. Without this constraint the results will be an averaging of the properties of the two regions near the interface between them.

### EXAMPLE

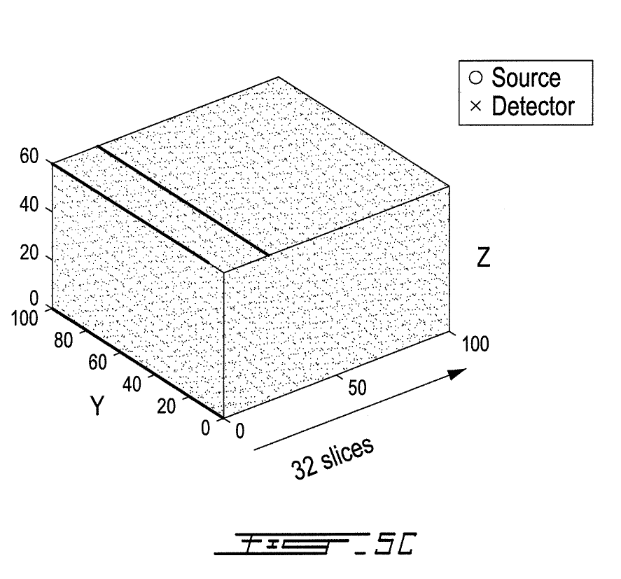

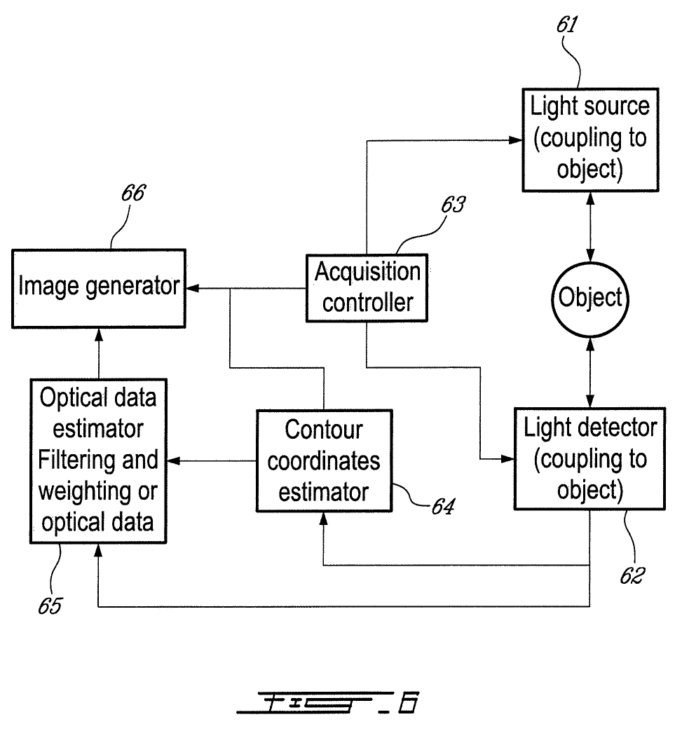

For the purpose of breast imaging, a time domain multi-wavelength system having slab geometry with the breast pendant in a rectangular tank and immersed in a scattering matching fluid can be used. In one embodiment, a single source with five associated detectors is raster scanned through the entire surface of the slab in increments of 3 mm. For each scan point, five detector positions are located in a transmission mode. For a source located at (0, 0, 0), the corresponding detector locations are Detector 1: (−25 mm, 5 mm, 60 mm), Detector 2: (25 mm, 5 mm, 60 mm), Detector 3: (0 mm, 0 mm, 60 mm), Detector 4: (−25 mm, −15 mm, 60 mm) and Detector 5: (25 mm, −15 mm, 60 mm). FIG. 5(a) shows the detector locations relative to a given source location, in a 3-D setting. FIG. 5(b) illustrates this geometry using a finite element mesh on a typical slab dimension of 96×96×60 mm having a total of 1024 source positions (32 along y direction by 32 along x-direction) shown at the bottom of the slab and 5120 detector locations indicated at the top of the slab (at z=60 mm). FIG. 5(c) shows the separation of the scan points into lines along x-axis, with each line containing all the scan points along the y-axis.

Prior to filling the tank, the breast contour is detected using the source and central detector in a line of sight CW mode (or quasi CW to minimize noise from the surrounding light). The source-detector pairs used to measure the contour can be different from those for measuring the optical properties.

While the invention has been described in connection with specific embodiments thereof, it will be understood that it is capable of further modifications and this application is intended to cover any variations, uses, or adaptations of the invention following, in general, the principles of the invention and including such departures from the present disclosures as come within known or customary practice within the art to which the invention pertains and as may be applied to the essential features herein before set forth, and as follows in the scope of the appended claims.

1. A method for optical imaging of an object in transmission configuration, the method comprising:
a) obtaining contour coordinates of the object using source/detector configurations references;
b) acquiring optical data from a region of interest (ROI) of the object;
c) applying a weighting factor to said optical data as a function of the contour coordinates; and
d) reconstructing an image of the ROI using the weighted optical data and photon diffusion equation.

2. The method as claimed in claim 1 wherein the step of obtaining contour coordinates comprises optically scanning the object to determine object boundaries.

3. The method as claimed in claim 1, wherein the source/detector configurations references comprises source/detector configuration coordinates in a field of view of a scanner.

4. The method as claimed in claim 1 wherein said object is comprised between two substantially parallel plates.

5. The method as claimed in claim 4 wherein said optically scanning comprises performing a raster scan.

6. The method as claimed in claim 4 wherein said contour coordinates are obtained in a plane parallel to said parallel plates and wherein a shape of said object in a plane perpendicular to said parallel plates is predetermined thereby providing a 3 dimensional (3D) contour.

7. The method as claimed in any one of claims 1 wherein the weighting factor is a function of optical properties of voxels outside of said ROI.

8. The method as claimed in any ones of claim 1 wherein optical data for which corresponding photon paths are outside of said contour coordinates of said object are excluded from said reconstructing step, and said reconstructing step generates a 3D image depicting optical properties of the object.

9. The method as claimed in any one of claims 8 further comprising a step of obtaining an average μₐ and μₛ′ for use in the step of reconstructing the image.

10. The method as claimed in any one of claims 9 further comprising a step of immersing said object in optically matching fluid.

11. A method for optical imaging of an object in transmission configuration, the method comprising:
a) obtaining contour coordinates of the object;
b) determining a region of interest (ROI) within said contour coordinates; and
c) acquiring optical data from said ROI of the object wherein said acquiring of optical data comprises adjusting a light source intensity as a function of said contour coordinates to maximize signal to noise ratio within said ROI.

12. The method as claimed in claim 11 wherein said contour is used to co-localize said ROI within optical images from different scans.

13. The method as claimed in claim 11 wherein said object is a breast.

14. A transmission optical imaging system comprising:
a) one or more light source for injecting light in an object;
b) one or more light detector for detecting light transmitted through said object;
c) an acquisition controller connected to said light source and light detector for collecting data at a plurality of source/detector configurations within said object;
d) a contour coordinate estimator for acquiring and calculating contour coordinates of the object;
e) an optical data estimator for selecting optical data relevant to said object as a function of contour coordinates, and for calculating and applying weighting factors to the optical data as a function of contour coordinates; and
f) an optical image generator for reconstructing an optical image based on said weighted optical data.

15. The transmission optical imaging system of claim 14, wherein the contour coordinate estimator is a raster scanner for optically scanning the object to determine the contour coordinates.
